(19) United States
(12) Patent Application Publication
(10) Pub. No.: US 2007/0199014 A1
(43) Pub. Date: Aug. 23, 2007

(54) Consumer portal

(75) Inventors: Darren L. Clark, Oakland, CA (US); Howard L. Spielman, San Francisco, CA (US)

Correspondence Address: MACPHERSON KWOK CHEN & HEID LLP, 2033 GATEWAY PLACE, SUITE 400, SAN JOSE, CA, 95110, US

(73) Assignee: E-Cast, Inc.

(21) Appl. No.: 11/360,795

(22) Filed: Feb. 22, 2006

(51) Int. Cl. G06F 13/00; H04N 5/445; H04N 7/16; G06F 3/00

(52) U.S. Cl. 725/30; 725/25; 725/39

(57) ABSTRACT

Systems and methods are described which provide consumers with information regarding the entertainment content available on the entertainment devices and to improve the ease with which the consumers can select songs and other entertainment content for performance on the entertainment device. A consumer at home may access a consumer portal over the Internet using a browser application. Through this portal, the consumer may select one or more entertainment content items to be saved in one or more playlists associated with a user identity specific to that consumer. The consumer may then travel to a venue where a network-enabled jukebox entertainment device is located. Using the user interface of the entertainment device, the consumer may log into their user account and retrieve the playlists previously created by the consumer at home. The consumer may then select one or more entertainment content items from that playlist for performance on the entertainment device.

### BACKGROUND

Traditional entertainment devices for out-of-home use, for example in restaurants or bars, are typified by the jukebox that plays selected vinyl records or compact discs after the insertion of coins or paper currency.

More recently, entertainment devices for public venues have begun to provide additional forms of entertainment beyond merely playing music from compact discs. Some entertainment devices are provided with personal computer architecture and are equipped with hard drives capable of storing huge libraries of music, video, and games. Patrons of the venue may operate the entertainment device to provide the desired service, such as to play a selected song or display a selected music video.

These entertainment devices may include displays for providing information regarding entertainment content currently being performed. For example, in CD-based jukeboxes, a CD identification number and track number for the currently playing song may be displayed on a digital LED display. More contemporary jukeboxes have been provided with video monitors that are capable of displaying rich text and graphics. These displays can present a graphical user interface for enabling consumers to browse the song catalog, enter music selections, and view detailed information regarding the current song, artist, and album being performed.

In order to improve brand loyalty and increase consumer usage of the entertainment devices, it would be desirable to provide consumers with more information regarding the entertainment content available on the entertainment devices, to improve the ease with which the consumers can select songs and other entertainment content for performance on the entertainment device, and to offer consumers rewards for brand loyalty.

### SUMMARY

Systems and methods are described which provide consumers with information regarding the entertainment content available on the entertainment devices and to improve the ease with which the consumers can select songs and other entertainment content for performance on the entertainment device. A consumer at home may access a consumer portal over the Internet using a browser application. Through this portal, the consumer may select one or more entertainment content items to be saved in one or more playlists associated with a user identity specific to that consumer. The consumer may then travel to a venue where a network-enabled jukebox entertainment device is located. Using the user interface of the entertainment device, the consumer may log into their user account and retrieve the playlists previously created by the consumer at home. The consumer may then select one or more entertainment content items from that playlist for performance on the entertainment device. Typically, this performance is provided in exchange for a fee paid by the consumer or by the proprietor of the venue.

The consumer portal may provide additional services to improve the consumer's experience, including improving the consumer's ability to browse and search the available entertainment content. For example, in some embodiments, a network of entertainment devices may be coupled to a central host system including a library of entertainment content items. Each entertainment device locally stores a subset of the library of entertainment content items for immediate performance upon request by consumers. As a default, the consumer portal may enable the consumer to browse and search the entire library of entertainment content available on the network. In addition, since the host system records the location of and the local content on each device, the consumer may be able to identify one or more specific venues on the network and browse and search the entertainment content that is currently locally available at each venue. The consumer may further be able to identify one or more venues as a “Favorite Venues”, such that those Favorite Venues are associated with the user identity. The consumer may then receive periodic informational updates relevant to the consumer's Favorite Venues, such as new content that has been recently added to the device. The consumer may also receive network-wide information, not specific to any location or device, such as artists newly available on the network, or new titles recently added to the network.

In accordance with embodiments of the present invention, a computer-implemented method of selecting entertainment content for performance is provided. The method includes: receiving login information corresponding to a user identity; receiving one or more entertainment content selections for storage in a playlist, wherein said playlist is associated with the user identity and comprises a list of one or more entertainment content items selected from a library of entertainment content available from a host system; receiving from an entertainment device login information corresponding to the user identity; receiving from the entertainment device a request for the playlist associated with the user identity, said entertainment device being adapted to perform entertainment content in response to user requests; and transmitting the playlist to the entertainment device.

In accordance with embodiments of the present invention, a computer-implemented method of selecting entertainment content items for performance is provided. The method includes: receiving login information at an entertainment device, said login information corresponding to a user identity; requesting from a host system one or more playlists associated with the user identity, wherein each playlist comprises a list of one or more entertainment content items selected from a library of entertainment content available from the host system; displaying the playlists at the entertainment device; receiving an input corresponding to selection of one of the entertainment content items; and in response to said input, performing the selected entertainment content item.

In accordance with embodiments of the present invention, an entertainment device is provided. The device includes: an audio system; a storage device for storing entertainment content to be performed upon request by the audio system; a user interface; and a control system configured to: receive login information from the user interface, said login information corresponding to a user identity; request from a host system one or more playlists associated with the user identity, wherein each playlist comprises a list of one or more entertainment content items selected from a library of entertainment content available from the host system; display the playlists; receive an input corresponding to selection of one of the entertainment content items; and in response to said input, perform the selected entertainment content item.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### DESCRIPTION OF THE DRAWINGS

FIG. 1 is a perspective view of an exemplary entertainment device, in accordance with embodiments of the present invention.

FIG. 2 is a simplified block diagram of an entertainment network, in accordance with embodiments of the present invention.

FIG. 3 shows a simplified block diagram of a host system, in accordance with embodiments of the present invention.

FIG. 4 shows a simplified block diagram of an entertainment device, in accordance with embodiments of the present invention.

FIG. 5 is an exemplary consumer portal login screen, in accordance with embodiments of the present invention.

FIG. 6 is an exemplary entertainment content browsing screen, in accordance with embodiments of the present invention.

FIGS. 7-10 show exemplary browsing screens for browsing and searching for entertainment content, in accordance with embodiments of the present invention.

### DETAILED DESCRIPTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description which follows are presented in terms of procedures, steps, logic blocks, processing, and other symbolic representations of operations on data bits that can be performed on computer memory. Each step may be performed by hardware, software, firmware, or combinations thereof.

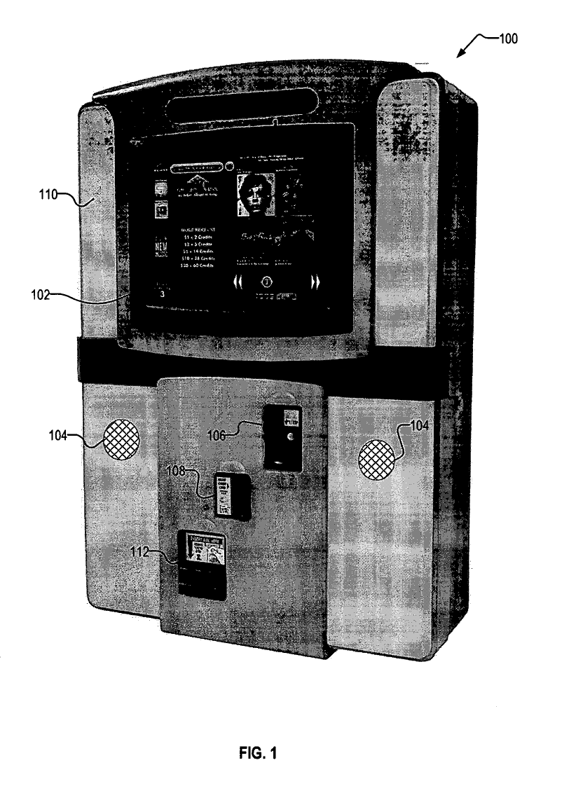

FIG. 1 is a perspective view of an exemplary entertainment device 100, in accordance with embodiments of the present invention. This entertainment device 100 comprises a housing 110 including an opening for a touch-screen video display 102. The entertainment device 100 also includes at least one audio speaker 104 and optionally a payment interface. In the illustrated embodiment, the payment interface comprises a cash payment collector and a non-cash payment collector. The cash payment collector comprises a coin collector 106 and a bill collector 112 for receiving cash payments from consumers in the form of coins, tokens, or bills. The non-cash payment collector comprises a card reader 108 for accepting payments from consumers using a credit card, debit card, smart card, magnetic strip token card, or other non-cash forms of payment.

In other embodiments, one or more of the payment collectors 106, 108, 112 may be omitted and/or other types of payment collectors may be added. For example, in some embodiments, the entertainment device may offer free selection of content to consumers, with payment made via a periodic lease, license, or subscription fee for the device, e.g., paid by the venue proprietor. In other embodiments, a consumer may log into the entertainment device 100 using a User ID. This User ID may be associated with prepaid credits or with a credit card for automatic debits in exchange for performance of entertainment content on the entertainment device 100.

The entertainment device 100 may also include audio and/or video outputs for transmitting audio and/or video signals for performance by external devices, such as loudspeakers and video displays provided elsewhere in the venue, to replace or supplement the speakers 104.

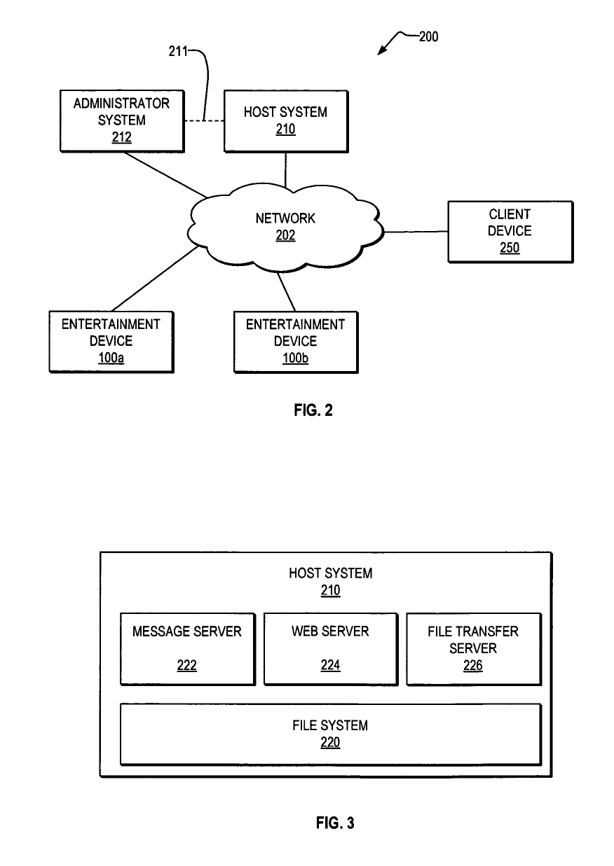

FIG. 2 shows a simplified block diagram of an entertainment network 200, in accordance with embodiments of the present invention. The network 200 comprises a host system 210 coupled to a plurality of entertainment devices 100a-100b over a network 202. The network 202 may comprise, e.g., a wide-area network (WAN), such as the Internet. In addition, one or more client devices 250 can communicate with the host system 210 via the network 202. The host system 210, the entertainment devices 100, and the client devices 250 may connect to the network 202 via various mechanisms, as would be understood by those of ordinary skill in the art. For example, the systems may have broadband connections to the Internet, and may be continuously or intermittently coupled to the network 202. Each of the entertainment devices 100 may be located in a public venue, such as a bar, restaurant, or arcade.

The host system 210 may comprise a central management system for controlling the various entertainment devices 100 and for distributing entertainment and advertising content, such as music, video, graphics, interactive surveys and quizzes, or text files, and operational content, such as software updates, to those devices 100. This host system 210 may take various forms, one example of which is shown in FIG. 3. The host system 210 shown in FIG. 3 comprises multiple components which may be implemented on a single server or across multiple servers. The illustrated host system 210 is a simplified block diagram of an exemplary host system with various components omitted for clarity, and in other embodiments, the host system 210 may be configured differently. As shown, the host system 210 comprises one or more message servers 222 which can transmit and receive messages to and from the entertainment devices 100 coupled to the network 202. In addition, the host system 210 further comprises a web server 224, which serves files that form Web pages accessible by clients via HTTP.

A file system 220 is provided for storing various files that may be downloaded by the entertainment devices 100. The file system 220 may comprise, e.g., a storage subsystem containing operational files, such as, e.g., software patches, executable programs, graphic files for use in the entertainment device's user interface, configuration setting files, or other files that may be used to control the operation of the entertainment device 100. The file system 220 may further contain advertising and entertainment content files such as, e.g., digital audio files, multimedia files, text files, game files, and other files that may be performed for or used by consumers at the venue location. The file system 220 may further store metadata associated with the entertainment content, such as, e.g., title, artist, and album information corresponding to each musical song file. One or more file transfer servers 226 may be provided for managing the transfer of files from the file system 220 to the various entertainment devices 100. Each of the files stored in the file system 220 may be associated with a unique Content ID to enable entertainment devices 100 to easily identify and retrieve files from the file system 220.

An administrator may manage the host system 210 directly or may use a separate administrator system 212 to interface with and control the host system 210. The administrator system 212 may comprise a separate computer system couplable to the host system 210 via a wide-area network (WAN), such as the network 202, or via a local-area network (LAN) 211.

The operation of a similar entertainment network is described in U.S. patent application Ser. No. 10/956,823, entitled “Prioritized Content Download for an Entertainment Device,” filed on Oct. 1, 2004, the contents of which are incorporated by reference herein in its entirety.

The client device 250 may comprise, e.g., a personal computer having a network interface for coupling with the network 202, a display for displaying a user interface, and one or more user input devices (e.g., a mouse and keyboard) for receiving inputs from a consumer. The client device 250 may further include a browser application for displaying web pages provided by the web server 224 and other web servers on the Internet. In other embodiments, the client device 250 may comprise other computing devices, such as, e.g., personal digital assistants, cellular phones, and set-top boxes.

The entertainment device 100 may comprise any of a variety of network-enabled entertainment devices, such as, e.g., freestanding jukeboxes, wall mounted jukeboxes, countertop units, and dedicated gaming units. These entertainment devices 100 may provide consumers with entertainment content in various forms, such as, e.g., audio, video, graphics, video games, software, text, and combinations thereof.

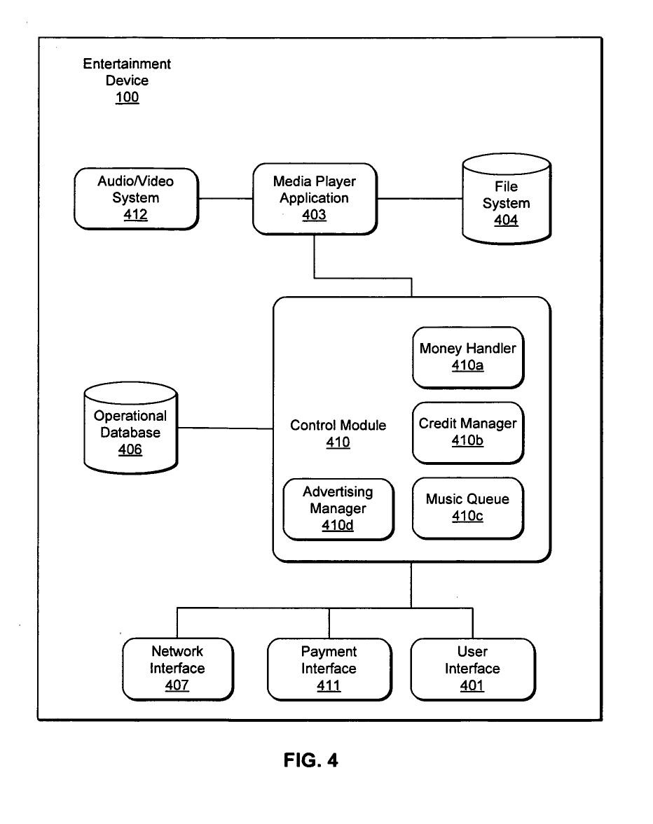

FIG. 4 is a simplified block diagram of an exemplary jukebox-type entertainment device 100. The entertainment device 100 may take various forms, but in the illustrated embodiment comprises a jukebox having a user interface 401, which may comprise a user input device enabling a consumer at the venue where the entertainment device 100 is located to input commands into the entertainment device 100. The user interface 401 may comprise, e.g., a keyboard, a touchpad, a mouse, a touch screen, or other input device, as would be understood by those of ordinary skill in the art. In the embodiment illustrated in FIG. 1, the user input device comprises a touch-screen display 102.

The entertainment device 100 also comprises an audio/video system 412, which enables the entertainment device 100 to perform entertainment content, e.g., in response to consumer requests, on a periodic basis (such as every ten minutes if there are no consumer requests pending), or according to a predetermined schedule. The audio/video system 412 may comprise an amplifier and audio speakers (e.g., speakers 104) for playing music and a monitor (e.g., display 102) for displaying video images. In other embodiments, the audio/video system 412 may couple to an amplifier and/or speakers located elsewhere in the venue 402 external to the entertainment device 100. A media player application 403 (such as, e.g. the Windows Media Player by the Microsoft Corporation of Redmond, Wash.) is provided for causing the audio/video system 412 to perform the requested entertainment content. For example, when the requested entertainment content comprises a song, the media player application 403 will retrieve from the file system 404 the digital file containing audio data (e.g., encoded using WMA or MP3 compression algorithms) corresponding to the requested song. The media player application 403 will process the digital file to produce an analog audio signal that can be played over loudspeakers located either within the entertainment device 100 or elsewhere in the venue.

A payment interface 411 may be provided for receiving the payment from consumers in exchange for providing the entertainment services. As shown in FIG. 1, the payment is received as cash payment in the coin collector 106 or the bill collector 112, or as non-cash payment into the card reader 108. When non-cash payment is received, the payment interface 411 may retrieve payment authorization from the financial services provider associated with that debit or credit card, a smart card reader, any combination of the above, or any other payment receiving mechanism.

A network interface 407 provides an interface between the entertainment device 100 and the network 202 and may comprise, e.g., an RJ-11 port, a wireless adapter, or a modem. An operational database 406 for storing various configuration setting values and information about the entertainment content is also provided. Finally, a control module 410 is provided for managing the various functions of the entertainment device 100. The control module 410 may comprise multiple modules for managing the various features of the entertainment device 100. These modules may include, for example, a money handler 410a for managing monetary payment from consumers, a credit manager 410b for managing the consumption of credits, a content performance queue 410c for managing the performance of entertainment content selected by consumers, and an advertising manager 410d for managing advertising content provided by the entertainment device 100, as will be described in greater detail below. The entertainment device 100 may be implemented using, for example, standard personal computer hardware and architecture.

The embodiment shown in FIG. 4 operates as follows. The entertainment device 100 includes a local file system 404 storing a plurality of different entertainment content files available to consumers. These consumers can utilize the user interface 401 and payment interface 411 to select and pay for the performance of entertainment content. The consumer may pay for the performance by inserting cash into one of the cash payment collectors. If the consumer attempts to pay for the performance using, e.g., a credit card or ATM card, the entertainment device 100 can connect to a payment authorization server on the network 202 in order to authorize the payment. In some embodiments, the consumer need not pay for the performance of entertainment content. This service may be paid for by the venue proprietor, or may be paid for through advertising campaigns displayed by the entertainment device 100. The control module 410 maintains a queue of requested entertainment content and will instruct the media player application 403 to play each requested entertainment content in turn from the queue or according to some other prioritization scheme.

A consumer requesting performance of entertainment content by the entertainment device 100 can select the content for performance in a variety of ways. In one embodiment, the entertainment device 100 includes a local catalog of entertainment content items (e.g., songs) that are locally stored in the file system 404 of the entertainment device 100. In addition, the entertainment device 100 may be configured to retrieve entertainment content items from full catalog of entertainment content items on the host system 210 via the network 202.

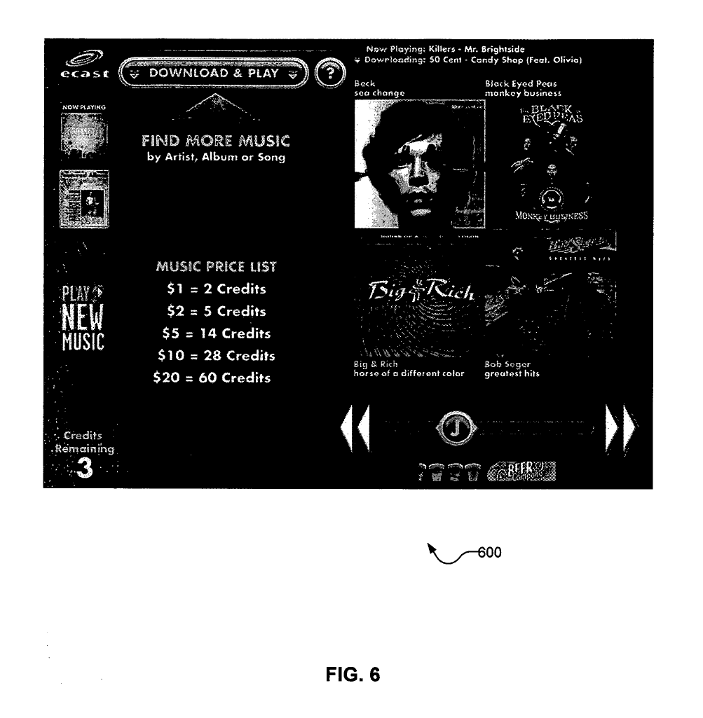

As in conventional jukeboxes, a consumer may select a song from the local catalog for performance by the entertainment device 100. The user interface 401 of the entertainment device may provide a browsing screen 600 (shown in FIG. 6) for allowing consumers to browse through the albums available on the local catalog. This local catalog is a subset of the full catalog of entertainment content items available on the host system 210. If the consumer wishes to request a song not included in the local catalog, the consumer may be able to request that a song from the full catalog be performed. In this case, the entertainment device 100 will retrieve the requested song from the host system 210 and perform the song for the consumer. The venue proprietor may opt to charge the consumer an extra fee for the performance of songs that are not locally stored, which is typically the case.

The control module 410 may also store a history of events that take place on the entertainment device 100. These events can include, e.g., entertainment content performed, revenue collected, and advertising events. For example, each time a song is played, that performance is recorded. The total performances of songs (and/or other types of entertainment content) by the entertainment device 100 is reported to the host system 210. This reporting may be required in order to satisfy royalty and/or licensing requirements for the entertainment content. The amount of revenue collected may be stored and reported back to the host system 210 so that the actual cash collections may be compared to the reported collections.

In order to communicate the event history from the entertainment device 100 to the host system 210, the control module 410 may transmit a message to the message server 222 of the host system 210 via the network 202 containing information regarding the events. This message may comprise, e.g., an XML message, and may include information such as, e.g., a Location ID uniquely identifying the venue where the content was performed, a Device ID uniquely identifying the device or disk drive that was used, the local time of the performance at the location, a Content ID uniquely identifying the performed entertainment content, an indication of whether the entertainment content was performed by request or by automatic playback, and the price paid for the performance. These messages may be sent each time an event occurs (e.g., each time an entertainment content item is requested or performed), or may be sent periodically including information regarding a plurality of events. The host system 210 receives the message from the entertainment device 100 and stores the historical performance records. The host system 210 can then retrieve aggregate performance data regarding all of the entertainment devices 100 on the network and specific performance data on the entertainment content being requested at each device 100. The communication between a host system and an entertainment device is described in co-pending U.S. patent application Ser. No. 11/083,592, entitled “Location-Based Historical Performance Information for Entertainment Devices”, to Darren L. Clark et al., filed on Mar. 18, 2005, incorporated by reference herein in its entirety.

The control module 410 may periodically contact the message server 222 of the host system 210 to request a manifest of files that the entertainment device 100 should have locally stored in order to possess a full complement of software and other files. This manifest may be delivered from the host system 210 to the entertainment device 100 as an XML document. If any files listed in the manifest are new or modified since the last time the control module 410 loaded its software, a content manager component of the control module 410 may request those files from the host system 210 in a process similar to the acquisition of new entertainment content. Once all of the files identified by the manifest have been acquired, at a predetermined time (or within a predetermined window of time), the files will be applied and the entertainment device 100 will reboot. The files listed on the manifest may include music catalogs, attract loops, and advertising content.

As described above, the operational database 406 may store various configuration settings for controlling the operation of the entertainment device 100. Each configuration value stored in the operational database 406 may be both centrally manageable (e.g., from the host system 210) or locally manageable (e.g., by an administrator interacting with the GUI interface of the entertainment device 100).

Consumer Portal

In accordance with embodiments of the present invention, a consumer may create a user identity (e.g., a user account) which can be accessed at one or more entertainment devices 100 on the entertainment network 200 and at one or more client devices 250. The consumer may then create and manage one or more playlists which are associated with the user account and can be retrieved at one of the entertainment devices 100 or client devices 250.

A playlist is a list of one or more user-definable entertainment content selections, each selection identifying an entertainment content item for performance. The playlist can enable a consumer to group entertainment content items together in a particular order. Often, a consumer will generate multiple playlists, with each playlist having a particular theme. For example, in the music jukebox context, a consumer may produce three playlists: a “My Favorites” playlist including a list of a consumer's favorite songs, a “Romantic” playlist including a list of a consumer's favorite romantic songs, and a “Dance” playlist including a list of a consumer's favorite dance songs.

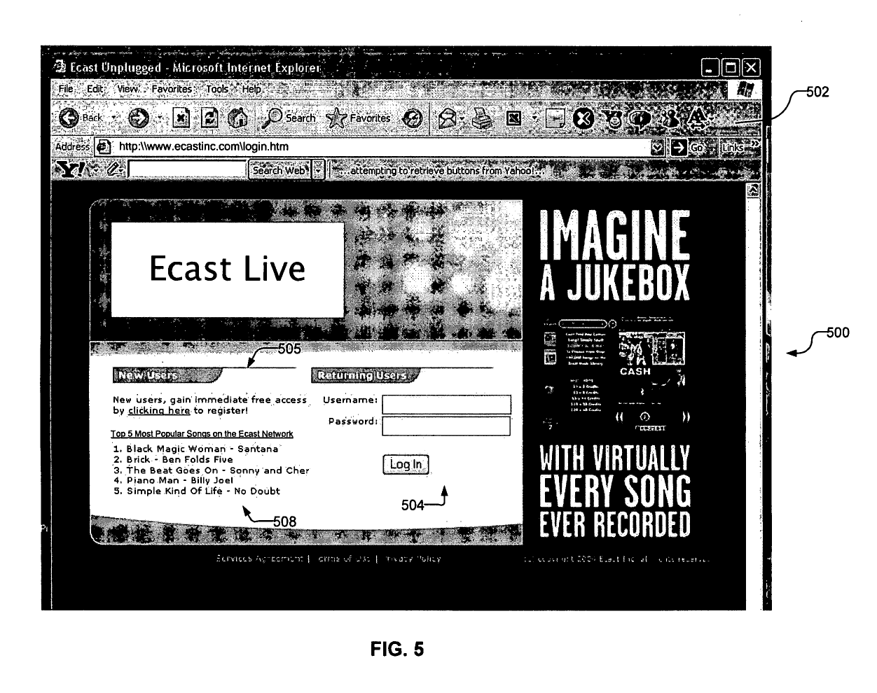

The consumer playlist may be generated in a variety of ways. In accordance with embodiments of the present invention, consumers may access a consumer portal in order to manage their playlists. FIG. 5 is an exemplary consumer portal login screen 500, in accordance with an embodiment of the present invention. A consumer may utilize a browser application 502 on a client device 250 (e.g., the consumer's home PC) to connect to the web server 224 of the host system 210.

The portal login screen 500 includes a login section 504, which includes input fields for a username and password. A consumer who has already registered with the network 200 may enter the username and password previously created upon registration. The portal login screen 500 may also include a new user registration section 506, which provides a link to one or more pages which request further information from the consumer in order to generate a new user account. The portal login screen 500 may also include additional information, such as a status section 508, which lists the five songs most frequently requested on the entertainment network 200.

Once the consumer has logged into the network 200, the web server 224 provides a user interface for browsing and/or searching the catalog of entertainment content available on the host system 210 for performance on the entertainment devices 100 of the entertainment network 200. The browsing and/or searching may be performed in a variety of ways.

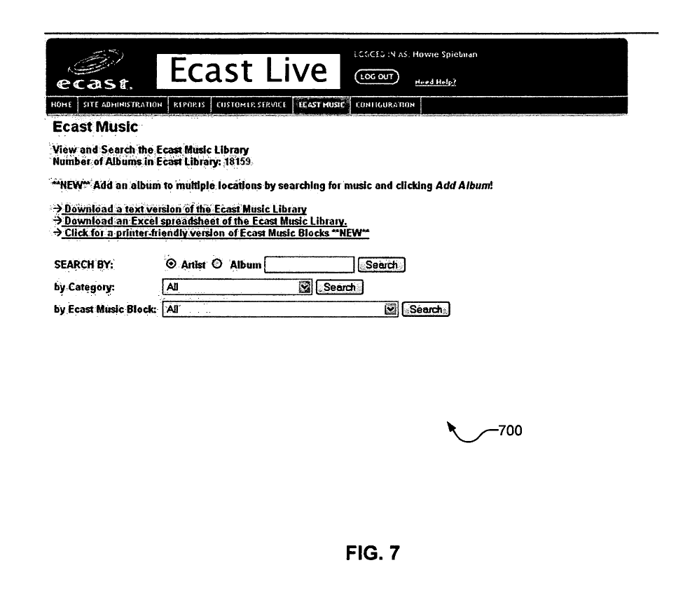

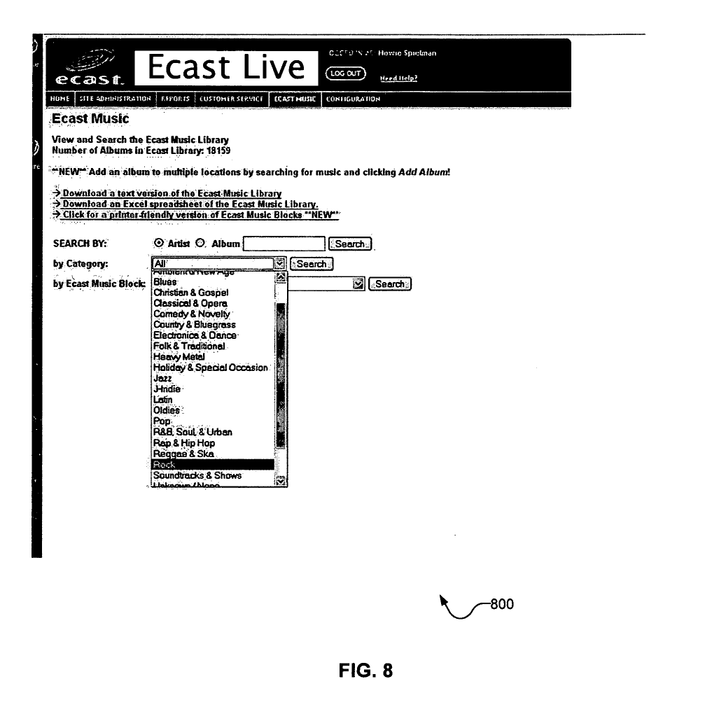

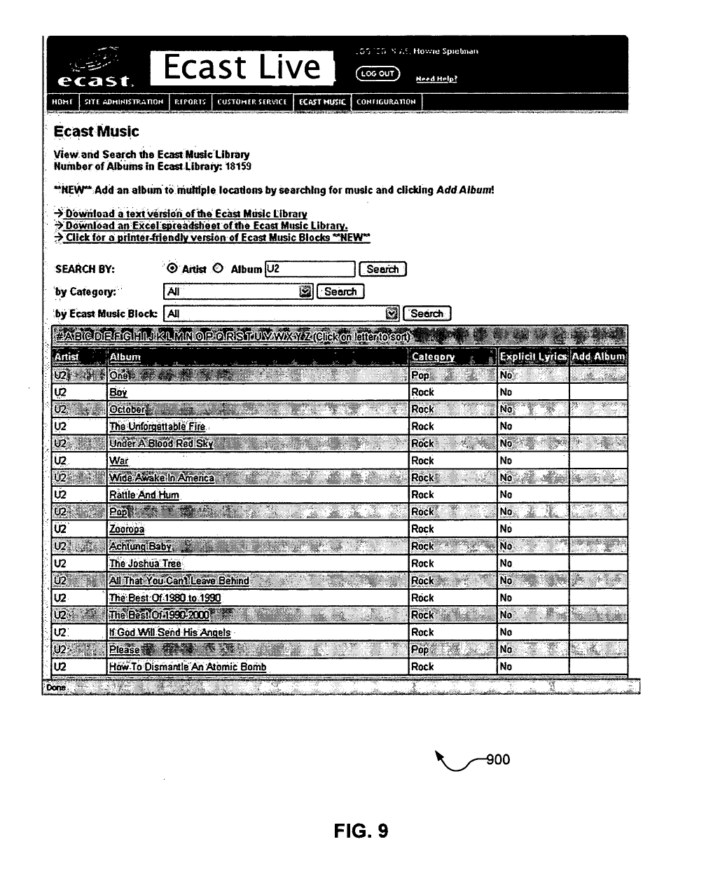

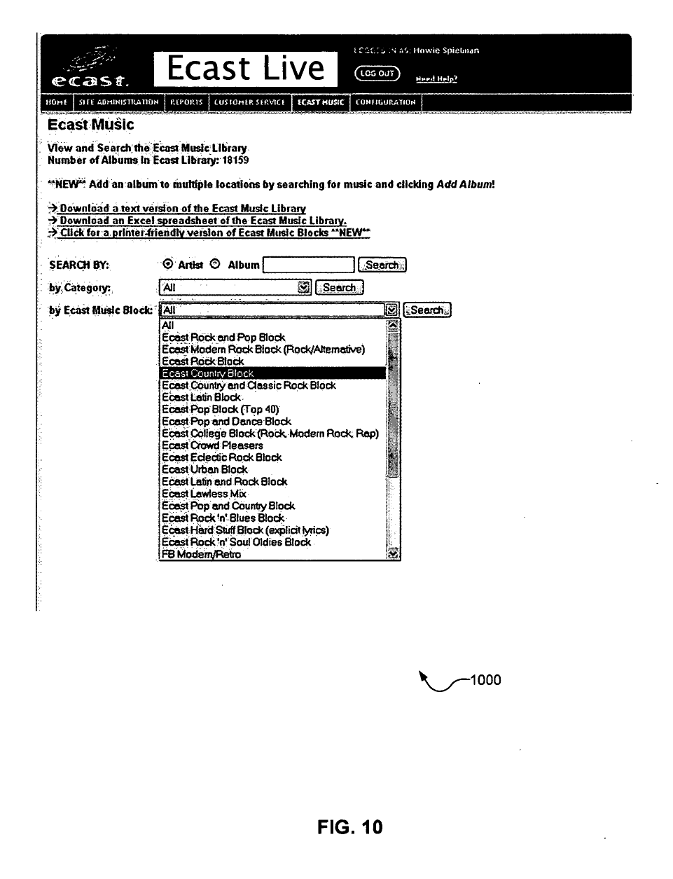

FIG. 7 shows an exemplary browsing screen 700 for browsing and searching for entertainment content. The browsing screen 700 allows the consumer to browse through all of the albums available in the full catalog of the host system 210. FIG. 8 shows a screen 800 illustrating the selection of a category of music from a pull-down menu. FIG. 9 shows a screen 900 illustrating the results list when a consumer performs a full-text search for the artist “U2.” FIG. 10 shows a screen 1000 illustrating the selection of a block of preselected music from a pull-down menu. In addition, the consumer portal may provide recommended entertainment content based on, e.g., popularity and/or content preferences provided by the consumer. The consumer portal may further provide searching functionality to search for entertainment content using various criteria, e.g., keyword, artist, track title, album title, etc.

Once the consumer has located a song or other entertainment content item in the full catalog, the consumer may add that song title or entertainment content listing to one or more of that consumer's playlists. These playlists are then stored in the host system 210 and associated with that consumer's user identity.

When the consumer visits a venue (e.g., a commercial establishment such as a bar, restaurant, nightclub, etc.) containing an entertainment device 100, the consumer may log into the consumer's account by entering the username and password associated with the consumer's user identity. This data can be entered, e.g., by utilizing an on-screen keyboard on the touch-screen display 102. The user identity can be authenticated by the host system 210, which verifies that the username and password are correct. In other embodiments, the user authentication may be accomplished in other ways. For example, the consumer may associate a credit card, debit card, or membership card with the user identity. On subsequent visits, when the consumer swipes the card through the card reader 108 of the entertainment device 100, the consumer's user identity may be automatically established and associated playlists retrieved.

After the user identity has been authenticated, the host system 210 may then transmit the playlists associated with that user identity to the entertainment device 100. This transmission may be performed automatically upon login, or may be performed upon request by the consumer (e.g., by touching an on-screen button labeled “Retrieve My Playlists”).

Once the consumer's playlists are retrieved, the consumer may select one or more entertainment content items listed in the playlists for performance by the entertainment device 100 in that venue. This performance is typically (but not always) done in exchange for payment (e.g., by the consumer or by the venue manager). This can save the consumer time by eliminating the need to browse or search through the entire local and/or full catalog of albums. In addition, either permanently or as part of special promotions, the entertainment device may be configured to offer consumers one or more bonus credits as an incentive for playing songs from a personal playlist. This can be accomplished, e.g., by utilizing a points program in which a consumer is awarded points for playing songs on an entertainment device selected from a personal playlist. These points can be redeemed for various rewards, such as bonus credits for free performance of entertainment content, priority performance of entertainment content on the entertainment device, or other type of incentive.

In addition to selecting entertainment content items from previously-created playlists, the consumer may also manage the playlists from the entertainment device 100. The consumer may utilize the user interface to add or delete entertainment content items. For example, if the consumer browses the local catalog and selects a song to be performed, the user interface may query the consumer whether the consumer would like to add the selected song to one of the consumer's playlists.

Location-Specific Playlists

Each entertainment device 100 on the network 200 may be customized by the device administrator, who can select the content to be locally stored on that device 100. This enables the administrator to select entertainment content suitable for the expected patrons of the venue in which the device 100 is located. For example, an entertainment device 100 located in a country-western bar would typically be provided with a local catalog focused on country-western music. In addition, over time, older albums in the local catalog may be replaced with newly-released albums. As a result, each entertainment device 100 on the network 200 can have a unique set of songs in the local catalog. Thus, when a consumer generates playlists at home, the consumer may be uncertain whether any particular entertainment device 100 would include the playlist selections in that device's local catalog.

In accordance with embodiments of the present invention, the consumer may utilize the consumer portal to obtain information about particular locations containing entertainment devices 100 on the network 200. The consumer may then create playlists tailored to the entertainment devices in specific locations.

For example, a consumer may identify a particular entertainment device 100 as the consumer's “Home Jukebox”. This Home Jukebox may be the entertainment device 100 in the location most frequently visited by the consumer. When utilizing the consumer portal, the consumer may browse and/or search the local catalog for the consumer's identified Home Jukebox. In addition, the consumer may create a “House Favorites” playlist based on selections from the local catalog for that Home Jukebox.

When the consumer logs into the entertainment device 100 designated as the Home Jukebox, the entertainment device 100 may be configured to provide a different experience than other devices 100 on the network. For example, when the consumer logs into an entertainment device 100 other than the Home Jukebox, the consumer is presented with a list of all of the consumer's previously-generated playlists and is prompted to select a playlist from the list. When the consumer logs into the consumer's Home Jukebox, the consumer's House Favorites playlist may be displayed first in the list. If the consumer logs into another entertainment device 100, the consumer's regular My Favorites playlist may be displayed first, with the House Favorites playlist for their Home Jukebox presented further down the list.

In accordance with other embodiments, the consumer may be able to associate the entertainment devices 100 in multiple locations with their user identity. For example, if a consumer regularly visits several establishments having entertainment devices 100 on the network 200, the consumer may wish to generate a House Favorites playlist for each establishment. When the consumer logs into the consumer portal, the user interface may provide a “My Locations” list of the consumer's previously-identified favorite venues. Then, when the consumer visits one of these favorite venues and logs into an entertainment device, the House Favorites playlist for that venue may be automatically presented to the consumer.

In some embodiments, the consumer may be provided with historical information regarding entertainment content performance. In FIG. 5, the consumer portal includes a status section 508 which lists the five songs most frequently requested on the entertainment network 200. In other embodiments, the consumer may be provided with a list of songs that the consumer had previously selected, or a list of songs selected by other patrons at one of their favorite locations. The consumer may then be provided with the option of adding one or more of those songs to one of the consumer's playlists. In yet other embodiments, the host system 210 may automatically generate a “Suggested Favorites” playlist including a list of entertainment content that the consumer might enjoy, based on the consumer's previous selections (either in playlists or on devices).

Location-Based Information

In accordance with other embodiments of the present invention, a consumer may be provided with information related to particular entertainment devices in specific locations. As described above, a consumer may identify one or more entertainment devices in the locations they frequently visit to be associated with the consumer's user identity. The consumer may then be provided with information regarding the entertainment devices identified in the consumer's “My Locations” list of favorite venues.

The host system 210 will allow the consumer to utilize the consumer portal to browse and/or search for entertainment content included in the local catalogs of the entertainment devices in the “My Locations” list, as well as other content available to the entire network. The portal may also provide the consumer with the ability to search for venues containing entertainment devices 100 in the entertainment network 200. The consumer may be able to search based on proximity to the consumer's residence or any other geographic location. In these instances, the host system responds to actions initiated by the consumer.

The host system 210 may also proactively provide a variety of notifications of timely information to the consumer. This information may be provided, for example, by periodically transmitting e-mail messages to an e-mail account associated with the user identity, or by sending text messages to a mobile device associated with the user identity. Alternatively, this information may be provided in the consumer portal each time the consumer logs into the portal, without the consumer specifically requesting it.

The type of information provided in these consumer notifications may also vary. For example, the consumer may receive location-based notifications relating to the consumer's favorite venues. This information may be related to changes in services and/or entertainment content available on the entertainment device in that favorite venue.

For example, each time an album is added to or removed from the local catalog for that entertainment device, the consumer may receive a message announcing the change. Alternatively, in order to reduce the number of notifications received by the consumer, it may be desirable to only provide notifications for entertainment content that is expected to be particularly relevant to the consumer. For example, when a song listed in the consumer's “My Favorites” list is removed from the local catalog of one of the consumer's favorite venues, a notification message may be transmitted to the consumer. Alternatively, the consumer may be notified each time the local catalog of a favorite location is updated with a new song or album from an artist having songs already included in the consumer's “My Favorites” list. The consumer may also explicitly identify “favorite artists”, so that the consumer would automatically receive notifications of new content from those favorite artists. The consumer may also be notified each time the local catalog of a favorite location is updated with a new song or album from an artist that is believed to be of interest to the consumer, based on the consumer's previous “My Favorites” selections and/or previous content selections at entertainment devices. In yet other embodiments, the notifications may be provided to consumers regarding similar changes occurring in the local catalog for entertainment devices in locations close to the consumer's favorite location.

The consumer may also be provided with notifications regarding changes to the entertainment network 200. For example, when the user identity is first established, the consumer may be prompted to provide a ZIP code, or a full home and/or work address. Then, each time a new entertainment device 100 is added to the entertainment network 200 in a location within a certain radius of the consumer's home and/or work addresses, the consumer may receive a notification updating the consumer of the new device. In some embodiments, the consumer may specify one or more types of music as being of particular interest. The notifications regarding new entertainment devices added to the network may be limited to those entertainment devices having content catalogs directed to one of those types of music. For example, if a consumer has specified indie music as being of particular interest, then the consumer would not receive a notification of a new entertainment device being installed in a nearby country-western bar.

In these examples, the consumer can expressly specify one or more characteristics, such as type of music or particular artist, which are used to define the type of notification received. In other embodiments, the characteristics may be inferred based on the consumer's other behavior. For example, if a consumer has selected a large number of songs that all belong to a certain type of music, then it may be inferred that the consumer prefers that type of music. Thus, the notifications to that consumer may be focused on that type of music.

In yet other embodiments, the consumer may utilize the consumer portal to convey information to the administrator of one of the consumer's favorite entertainment devices. This information may comprise, e.g., requests that a particular song, album, artist, or genre be added to the local catalog of that entertainment device. The consumer may also provide the administrator with feedback about the venue, such as complaints that the entertainment device is too loud or too quiet.

The conveying of information from consumers to the administrators may be performed in a variety of ways. For example, the consumer may be provided with an e-mail address for contacting the administrator. Alternatively, the consumer portal may include a feedback screen having fields which may be completed by the consumer. The information received from the consumers may be directly transmitted by the host system 210 to the administrators. Alternatively, the host system 210 may compile the consumer-provided information and provide the compiled information to the administrators. For example, the host system 210 may provide a report to each administrator including a list of requested songs and the number of votes for each requested song.

Incentives

In many cases, consumers are busy and are not inclined to establish user identities and to visit a consumer portal web site for their local jukeboxes. In accordance with embodiments of the present invention, consumers may be provided with incentives for establishing user identities and playlists accessible through the consumer portal.

In one embodiment, a consumer who has requested performance of entertainment content on an entertainment device 100 may be offered a reward for entering an e-mail address. This reward may comprise, e.g., one or more credits towards the performance of additional entertainment content. Once the e-mail address or other electronic contact information, such as an instant messaging address, is received, the host system 210 may transmit a message to the consumer with a link to the consumer portal login screen 500. Once the consumer connects to the login screen 500 and creates a user identity, the user identity will be provided with one or more credits. In the future, when the consumer logs into an entertainment device 100 using the newly-created user identity, the consumer will be able to redeem these credits.

In accordance with other embodiments, the consumer may receive rewards for providing a variety of information to be associated with the user identity, such as, e.g., creating playlists, providing a home and/or work address, identifying favorite venues, signing up for e-mail updates, etc.

In yet other embodiments, consumers may receive a discount on the cost of requesting performance of entertainment content identified on the consumer's playlists. For example, if the cost of requesting a standard song from the local catalog is two credits, the consumer may be allowed to request performance of a song from the consumer's playlist for one credit. Another possible way to reward consumers for registration and the use of their playlist would be to issue one or more bonus credits based on the level of utilization of the playlist for actually performing content on an entertainment device.

Embodiments of the present invention may provide various advantages not provided by prior art systems. The generation of playlists on the consumer portal can save the consumers time by eliminating the need to browse or search through the entire local and/or full catalog of albums while making music selections. In addition, by allowing consumers to browse and search through the catalog of entertainment content at home, the consumers may have more time to look for appealing content in a leisurely way, without having to stand in front of a jukebox and forcing other consumers to wait to use the jukebox.

In addition, the creation of user identities can enable the administrators of the entertainment network 200 to better connect with consumers. The consumer portal can provide consumers with additional information regarding services and content provided by the entertainment network 200, and this information can be personalized to the consumer based on information explicitly provided by the consumer or based on historical selection information. In addition, the administrators can receive valuable feedback on content and services from consumers. Moreover, the entertainment network 200 maintains an ongoing relationship with consumers, thereby improving brand recognition and loyalty.

In some embodiments, the ability to provide detailed information regarding consumers can help to increase advertising revenue on entertainment devices 100 which include advertisements. The ability to provide detailed demographic information regarding viewers of advertisements can provide improved consumer targeting for advertisers, thereby justifying increased advertising rates. The use of user accounts can enable more precise tracking of consumer spending patterns and interests.

While the invention has been described in terms of particular embodiments and illustrative figures, those of ordinary skill in the art will recognize that the invention is not limited to the embodiments or figures described. For example, various embodiments have been described with respect to jukeboxes configured to play music. In other embodiments, the entertainment content listed in the consumer playlists and performed by the entertainment devices may comprise music, video, games, and other types of entertainment.

In addition, the embodiments described herein relate to the use of web-based browser applications for accessing the consumer portal. In other embodiments, different applications may be used to communicate between the client devices and the host system.

The program logic described indicates certain events occurring in a certain order. Those of ordinary skill in the art will recognize that the ordering of certain programming steps or program flow may be modified without affecting the overall operation performed by the preferred embodiment logic, and such modifications are in accordance with the various embodiments of the invention. Additionally, certain of the steps may be performed concurrently in a parallel process when possible, as well as performed sequentially as described above.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A computer-implemented method of selecting entertainment content for performance, comprising:
receiving login information corresponding to a user identity;
receiving one or more entertainment content selections for storage in a playlist, wherein said playlist is associated with the user identity and comprises a list of one or more entertainment content items selected from a library of entertainment content available from a host system;
receiving from an entertainment device login information corresponding to the user identity;
receiving from the entertainment device a request for the playlist associated with the user identity, said entertainment device being adapted to perform entertainment content in response to user requests; and
transmitting the playlist to the entertainment device.

2. The method of claim 1, wherein:
said receiving login information corresponding to the user identity comprises receiving from a client device login information corresponding to the user identity; and
said receiving one or more entertainment content selections comprises receiving from the client device one or more entertainment content selections.

3. The method of claim 2, wherein:
said receiving from the client device one or more entertainment content selections comprises receiving from the client device via a wide area network (WAN) one or more entertainment content selections.

4. The method of claim 2, further comprising:
transmitting a web page to the client device, said web page comprising a user interface for selecting entertainment content for storage in a playlist;
wherein said receiving one or more entertainment content selections for storage in the playlist comprises receiving one or more entertainment content selections for storage in the playlist via the web page.

5. The method of claim 2, further comprising:
providing a browsing interface to the client device for browsing entertainment content locally stored on the entertainment device.

6. The method of claim 1, wherein:
said receiving from the entertainment device login information corresponding to the user identity comprises receiving user information read by a card reader on the entertainment device, said user information being associated with the user identity.

7. The method of claim 1, further comprising:
receiving an identification of a favorite location including an entertainment device, wherein the entertainment device at the favorite location is configured to retrieve entertainment content from the host system.

8. The method of claim 7, wherein:
said playlist is associated with the entertainment device in the identified favorite location.

9. The method of claim 7, further comprising:
transmitting information regarding changes to a catalog of entertainment content locally stored on the entertainment device in the identified favorite location.

10. The method of claim 7, further comprising:
receiving a request for a change to a catalog of entertainment content locally stored on the entertainment device in the identified favorite location.

11. The method of claim 1, further comprising:
providing an incentive for requesting performance of entertainment content selected from the playlist.

12. The method of claim 11, wherein:
said incentive comprises providing credit or discount towards requesting performance of entertainment content.

13. The method of claim 11, wherein:
said incentive comprises providing priority performance of entertainment content on the entertainment device.

14. A computer-implemented method of selecting entertainment content items for performance, comprising:
receiving login information at an entertainment device, said login information corresponding to a user identity;
requesting from a host system one or more playlists associated with the user identity, wherein each playlist comprises a list of one or more entertainment content items selected from a library of entertainment content available from the host system;
displaying the playlists at the entertainment device;
receiving an input corresponding to selection of one of the entertainment content items; and
in response to said input, performing the selected entertainment content item.

15. The method of claim 14, wherein:
said requesting from the host system comprises requesting from the host system via a wide area network (WAN) the playlist associated with the user identity.

16. The method of claim 14, wherein:
said playlist is generated based on user instructions received from a client device distinct from the entertainment device.

17. The method of claim 14, wherein:
said playlist is associated with a location in which the entertainment device is provided.

18. The method of claim 14, wherein:
said playlist is generated based on user instructions received from the entertainment device.

19. The method of claim 14, further comprising:
providing an incentive for requesting performance of entertainment content selected from the playlist.

20. The method of claim 19, wherein:
said incentive comprises providing credit towards requesting performance of entertainment content.

21. The method of claim 19, wherein:
said incentive comprises providing priority performance of entertainment content on the entertainment device.

22. An entertainment device, comprising:
an audio system;
a storage device for storing entertainment content to be performed upon request by the audio system;
a user interface; and
a control system configured to:
receive login information from the user interface, said login information corresponding to a user identity;
request from a host system one or more playlists associated with the user identity, wherein each playlist comprises a list of one or more entertainment content items selected from a library of entertainment content available from the host system;
display the playlists;
receive an input corresponding to selection of one of the entertainment content items; and
in response to said input, perform the selected entertainment content item.

23. The entertainment device of claim 22, wherein the control system is configured to:
request from the host system via a wide area network (WAN) the playlist associated with the user identity.

24. The entertainment device of claim 22, wherein the control system is configured to:
generate said playlist based on user instructions received from a client device distinct from the entertainment device.

25. The entertainment device of claim 22, wherein:
said playlist is associated with a location in which the entertainment device is provided.

26. The entertainment device of claim 22, wherein:
said playlist is generated based on user instructions received from the entertainment device.

27. The entertainment device of claim 26, wherein the control system is further configured to:
provide an incentive for requesting performance of entertainment content selected from the playlist.

28. The entertainment device of claim 27, wherein:
said incentive comprises providing credit or discount towards requesting performance of entertainment content.

29. The entertainment device of claim 27, wherein:
said incentive comprises providing priority performance of entertainment content on the entertainment device.
